(19) United States
(12) Patent Application Publication
(10) Pub. No.: US 2018/0329951 A1
(43) Pub. Date: Nov. 15, 2018

(54) ESTIMATING THE NUMBER OF SAMPLES SATISFYING THE QUERY

(71) Applicant: Futurewei Technologies, Inc., Plano, TX (US)

(72) Inventors: Jiangsheng Yu, San Jose, CA (US); Shijun Ma, Milpitas, CA (US); Qingqing Zhou, Plano, TX (US)

(73) Assignee: Futurewei Technologies, Inc., Plano, TX (US)

(21) Appl. No.: 15/593,120

(22) Filed: May 11, 2017

(51) Int. Cl. G06F 17/30; G06N 99/00

(52) U.S. Cl. CPC G06F 17/30445; G06N 99/005; G06F 17/30477

(57) ABSTRACT

The disclosure relates to technology for estimating a number of samples satisfying a database query. One or more subsets from a sample dataset of a collection of all data are randomly drawn. The one or more subsets are queried to determine a number of cardinalities as training data. A prediction model based on the training data is then trained using machine learning or statistical methods, and a sample size satisfying the database query of the collection of all data is estimated using the trained prediction model.

### BACKGROUND

Data incorporating large quantities of variables is becoming increasingly commonplace, especially in data sets that are sufficiently large that they may be generated and/or stored by multiple computing devices. In addition to the challenges of handling such a large quantity of data, increasing the quantity of variables in a data set by even a small degree tends to add exponentially to at least the complexity of relationships among the data values, and may result in an exponential increase in data size.

Among such challenging data sets are large random samples generated by various forms of statistical analysis. Performance testing is essential for quality assurance of products and services across all industries. A reliable performance testing depends largely on proper testing data, which is not always accessible for testing purposes. Accordingly, developers and manufacturers are challenged with providing testing data for testing products and services where such testing data may not be obtainable. As a result, precision of the testing results is often inaccurate or misleading since the performance testing data was not available.

### BRIEF SUMMARY

According to one aspect of the present disclosure, there is provided a computer-implemented method for estimating a number of samples satisfying a database query, the method including randomly drawing one or more subsets from a sample dataset of a collection of all data; querying on the one or more subsets to determine a number of cardinalities as training data; training a prediction model based on the training data using machine learning or statistical methods; and estimating a sample size satisfying the database query of the collection of all data using the trained prediction model.

Optionally, in any of the preceding aspects, the method further includes randomly generating one or more samples to form the sample dataset from the collection of data stored in the database; constructing the training data for one or more resampled subsets.

Optionally, in any of the preceding aspects, each of the randomly generated one or more subsets has a distinct size corresponding to the number of samples.

Optionally, in any of the preceding aspects, the training data is a set of data defined by pairs of a distinct size and the number of samples that satisfy the query for a corresponding one of the one or more subsets.

Optionally, in any of the preceding aspects, the determining the number of samples in each of the one or more subsets that satisfy the given query is performed by one or more processors in parallel.

According to one aspect of the present disclosure, there is provided a device for estimating a number of samples satisfying a database query, including a non-transitory memory storage comprising instructions; and one or more processors in communication with the memory, wherein the one or more processors execute the instructions to perform operations comprising: randomly drawing one or more subsets from a sample dataset of a collection of all data; querying on the one or more subsets to determine a number of cardinalities as training data; training a prediction model based on the training data using machine learning or statistical methods; and estimating a sample size satisfying the database query of the collection of all data using the trained prediction model.

Optionally, in any of the preceding aspects, the device further includes randomly generating one or more samples to form the sample dataset from the collection of data stored in the database; constructing the training data for one or more resampled subsets.

Optionally, in any of the preceding aspects, each of the randomly generated one or more subsets has a distinct size corresponding to the number of samples.

Optionally, in any of the preceding aspects, the training data is a set of data defined by pairs of a distinct size and the number of samples that satisfy the query for a corresponding one of the one or more subsets.

Optionally, in any of the preceding aspects, the determining the number of samples in each of the one or more subsets that satisfy the given query is performed by one or more processors in parallel.

According to one aspect of the present disclosure, there is provided a non-transitory computer-readable medium storing computer instructions for estimating a number of samples satisfying a database query, that when executed by one or more processors, perform the steps of randomly drawing one or more subsets from a sample dataset of a collection of all data; querying on the one or more subsets to determine a number of cardinalities as training data; training a prediction model based on the training data using machine learning or statistical methods; and estimating a sample size satisfying the database query of the collection of all data using the trained prediction model.

Optionally, in any of the preceding aspects, the non-transitory computer readable medium further includes randomly generating one or more samples to form the sample dataset from the collection of data stored in the database; constructing the training data for one or more resampled subsets.

Optionally, in any of the preceding aspects, each of the randomly generated one or more subsets has a distinct size corresponding to the number of samples.

Optionally, in any of the preceding aspects, the training data is a set of data defined by pairs of a distinct size and the number of samples that satisfy the query for a corresponding one of the one or more subsets.

Optionally, in any of the preceding aspects, the determining the number of samples in each of the one or more subsets that satisfy the given query is performed by one or more processors in parallel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example of a distributed data processing system in which embodiments of the disclosure may be implemented.

FIG. 2 illustrates an example machine learning system that may be implemented in the system of FIG. 1.

FIG. 3 illustrates an example process of estimating a number of samples to satisfy a query in accordance with embodiments disclosed herein.

FIGS. 4A-4D illustrate flow diagrams for estimating a number of samples satisfying a query in accordance with the disclosed embodiments.

FIG. 5 illustrates a chart representing sample sizes estimated based on the trained predictive model.

FIG. 6 illustrates a block diagram of a network system that can be used to implement various embodiments.

### DETAILED DESCRIPTION

The disclosure relates to technology for generating random numbers that are distributed by a population distribution.

In statistics, traditional resampling methods such as bootstrapping or jackknifing, allow for the estimation of the precision of sample statistics (e.g., medians, variances, percentiles) using subsets of data or by drawing randomly with replacement from a set of data points. In such instances, no new sample points are generated. That is, only data points from otherwise available data may be sampled. Thus, data that is unavailable may not be used as part of the resampling methodology.

According to embodiments of the disclosure, the proposed methodology provides for estimating a number of samples that satisfies a database query. Subsets from a sample dataset of a collection of all data are randomly drawn. Once drawn, the subsets are queried to determine a number of cardinalities. The number of cardinalities may then be used as training data to train a prediction model using machine learning or statistical methods. The trained prediction model may then be used to estimate a sample size satisfying the database query of the collection of all data.

It is understood that the present embodiments of the disclosure may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

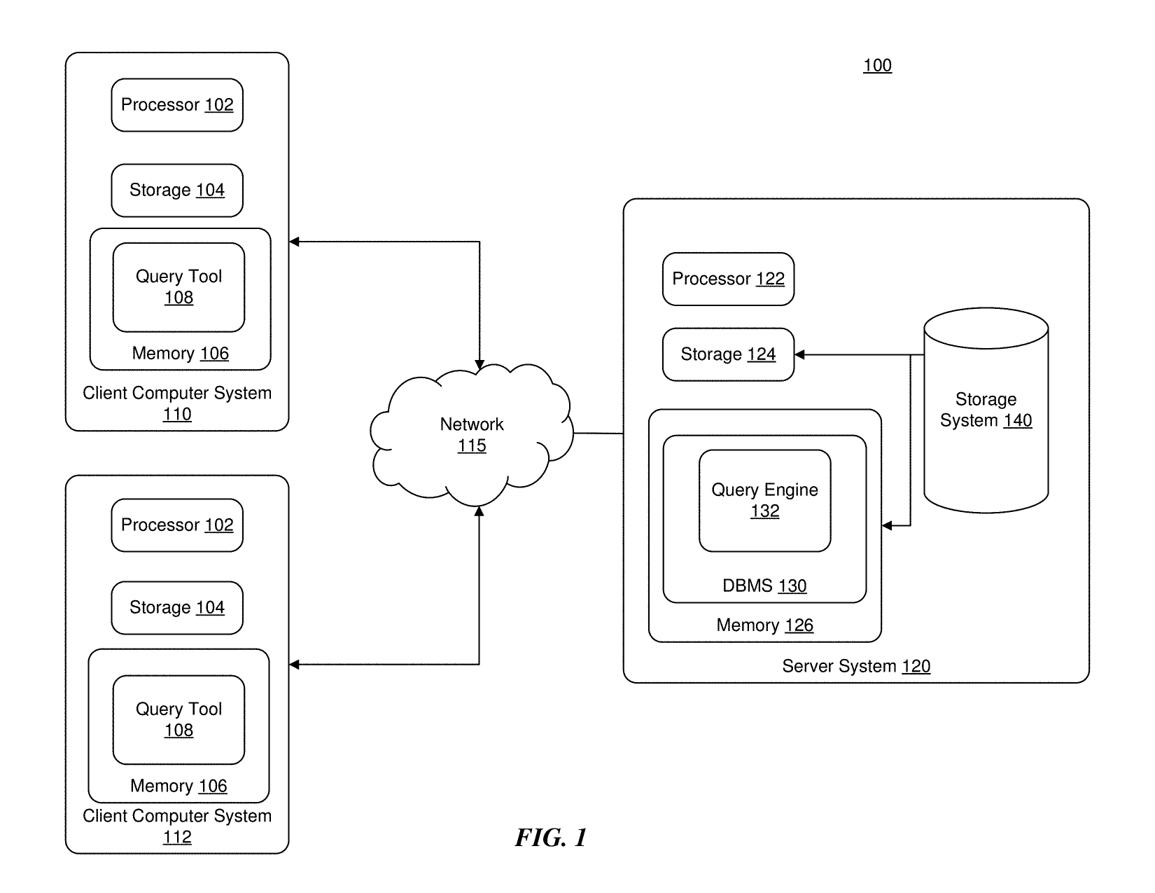

FIG. 1 illustrates an example diagram of a database management system in which query processing may be implemented. As shown, computing environment 100 includes two client computer systems 110 and 112, a network 115 and a distributed server system 120. The computer systems illustrated in computing environment 100 are included to be representative of existing computer systems, e.g., desktop computers, server computers, laptop computers, tablet computers and the like.

It is appreciated that embodiments of the disclosure are not limited to any particular computing system, application or network architecture and may be adapted to take advantage of new computing systems as they become available. Additionally, those skilled in the art will recognize that the computer systems illustrated in FIG. 1 are simplified to highlight aspects of the present embodiments and that computing systems and networks typically include a variety of additional elements not shown. For example, the system is not limited to two client computing systems or a single server, but may include any number of systems and servers.

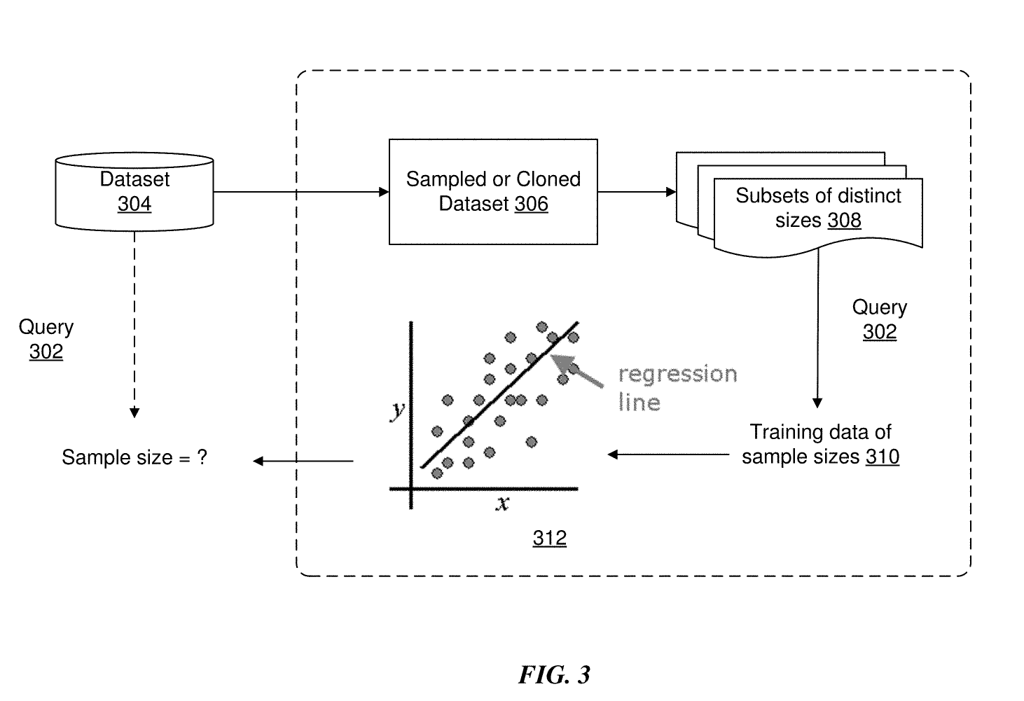

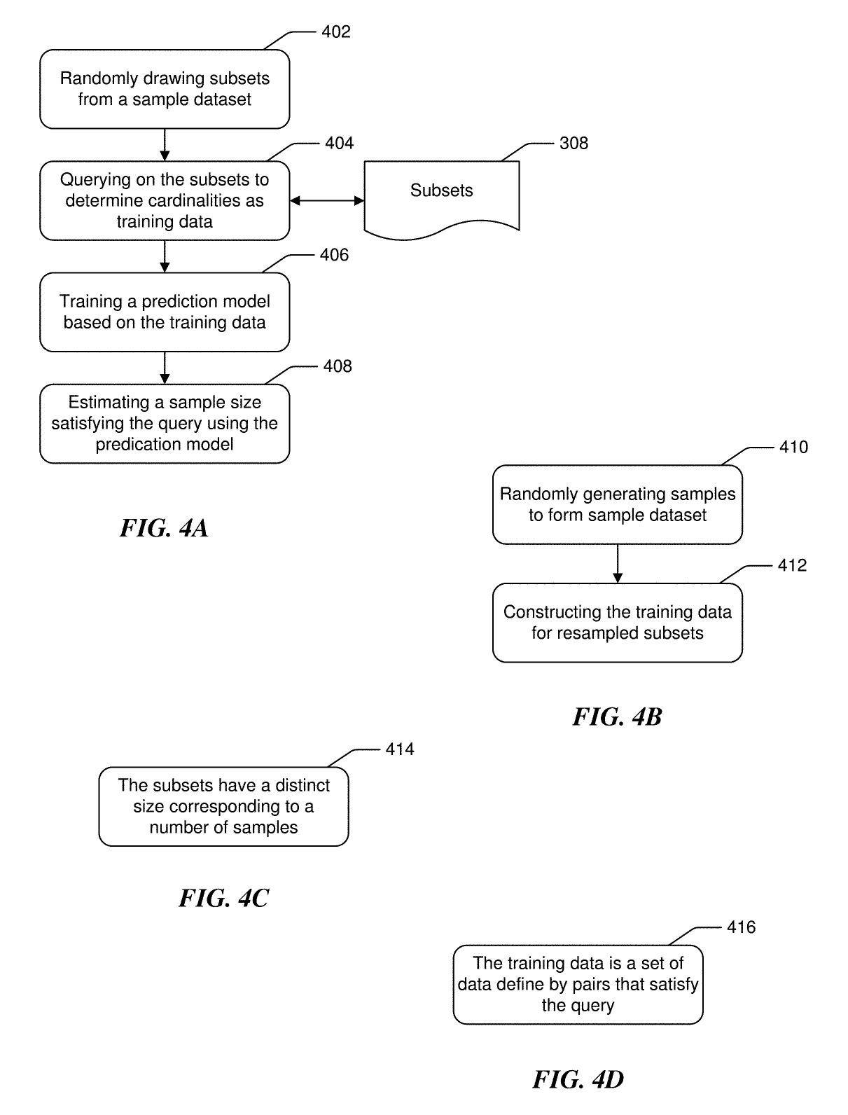

Client computer systems 110 and 112 each include, for example, a processor 102, storage 104 and memory 106, typically connected by a bus (not shown). Processor 102 is, for example, a programmable logic device that performs the instructions and logic processing performed in executing user applications. Although illustrated as a single processor, the processor 102 is not so limited and may comprise multiple processors. The processor 102 may be implemented as one or more central processing unit (CPU) chips, cores (e.g., a multi-core processor), field-programmable gate arrays (FPGAs), application specific integrated circuits (ASICs), and/or digital signal processors (DSPs), and/or may be part of one or more ASICs. The processor 102 may be configured to implement any of the schemes described herein, such as the processes illustrated in FIGS. 3 and 4A-4D using any one or combination of steps described in the embodiments. Moreover, the processor 102 may be implemented using hardware, software, or a combination of hardware and software.

Storage 104 may store application programs and data for use by client computer systems 110 and 112. Storage 104 includes hard-disk drives, flash memory devices, optical media and the like and represents any device or combination of devices configured to store data for use by storage system 140. Such data may include database information, data schema, the data generating rules, data patterns and trends, and historical sampling data.

Client computer systems 110 and 112 may also run a query tool 108, which is stored in memory 106. The memory 106 is illustrated as a single memory, although memory 106 may be implemented as a combination of read only memory (ROM), random access memory (RAM), or storage 104 (e.g., one or more disk drives or tape drives used for non-volatile storage of data). In one embodiment, query tool 108 may allow a user to compose a query, where query tool 108 is configured to automatically determine Boolean logic and generate a predicate, for example, as a Boolean expression. Additionally, query tool 108 may be configured to transmit a query over network 115 to server system 120 for execution by a database management system (DBMS) 130.

In embodiments, the network 115 represents one or more of a cable, wireless, fiber optic, or remote connections via a telecommunication link, an infrared link, a radio frequency link, or any other connectors or systems that provide electronic communication. The network 102 may include, an intranet, the Internet or any combination, and also include intermediate proxies, routers, switches, load balancers, and the like.

Computer systems 110 and 112 may include, but are not limited to, a notebook computer, a desktop computer, a laptop computer, a handheld computing device, a mobile phone or a smartphone, a tablet computing device, a portable reading device, a server, or any other processing device. In one embodiment, computer systems 110 and 112 and server system 120 may be connected to each other by direct wireless personal area networks (WPANs) and/or peer-to-peer connections in addition to, or instead of, their connection to network 115.

Server system 120 includes, for example, a processor 122, storage 124 and memory 126. In one embodiment, the server 104 provides data, such as boot files, operating system images, and applications to clients 110 and 112. The server system 120 may be, for example, any computing devices configured to respond to network requests received from client devices 110 and 112, and may include a web server, an application server, a file server, or a database server or the like.

Storage 124 also includes a storage system 140 (or database). Storage system 140, although depicted as part of the server system 120, may also be located outside of the server system 120 and communicatively coupled to the network 115. Moreover, it is appreciated that there may be more than one storage system (or database), and that the storage system may be any type of known database, database system, data stores, and the like.

In one embodiment, the DBMS 130 is a software application configured to manipulate the information in storage system 140. For example, DBMS 130 may be configured to add, delete, modify, sort, display and search for specific information stored in storage system 140. In the depicted embodiment, DBMS 130 includes a query engine 132 which represents the instructions or routines included in DBMS 130 that evaluate logical operators and query conditions, according to a set of rules as described herein.

In one embodiment, the query tool 108 generates a query from user-specified query conditions. The queries generated by query tool 108 may be used to retrieve data from storage system 140. However, in one embodiment, query tool 108 does not require the user to specify any Boolean logical operators or to determine the order and precedence used by DBMS 130 and query engine 132 to evaluate and reduce the query conditions.

It is appreciated that the processes and methodologies described herein may be implemented in a client device or a server. For example, the processes described herein may be implemented in a server, such as server system 120, that obtain data from various data sources connected via the network 115. In response to a request from a client device, such as client computer systems 110 and 112, the server system 120 collects the data for evaluation.

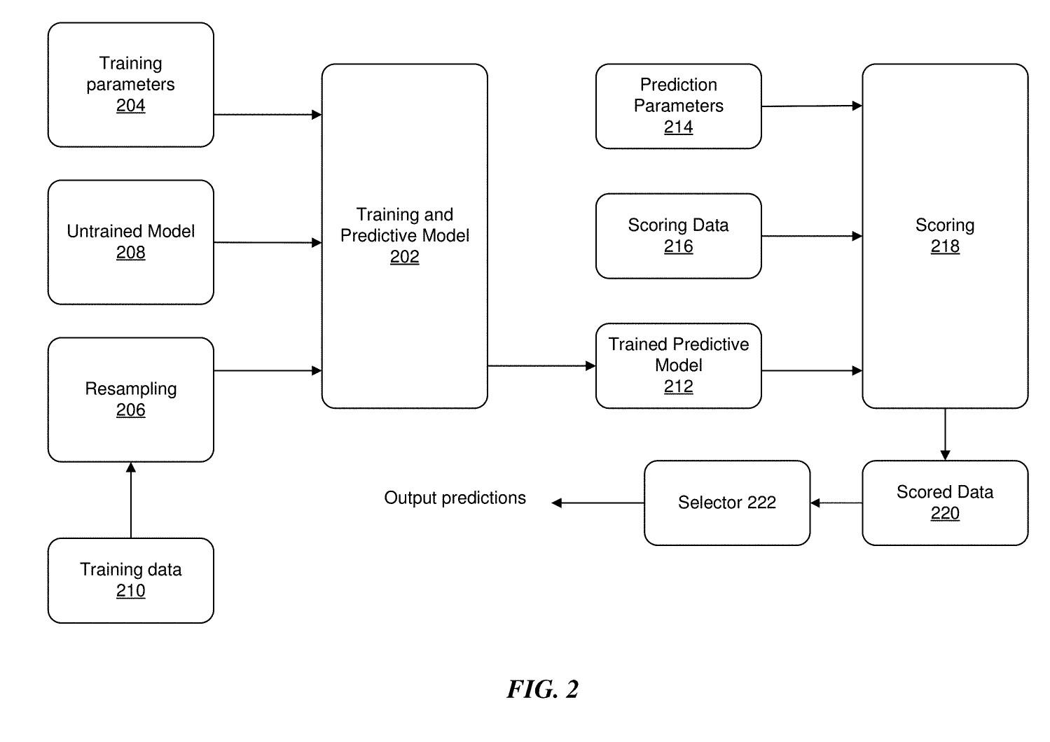

FIG. 2 illustrates an example machine learning system that may be implemented in the system of FIG. 1. Machine Learning uses a number of statistical methods and techniques to create predictive models for classification, regression, clustering, manifold learning, density estimation and many other tasks. A machine-learned model summarizes the statistical relationships found in raw data and is capable of generalizing them to make predictions for new data points.

In the field of machine learning, commonly used prediction methods Include, but are not limited to, k-nearest neighbors, Support Vector Machines, Naïve Bayes and C4.

The k-nearest neighbors method (“k-NN”) is an example of an instance-based, or “lazy-learning” method. In lazy learning methods, new instances of data are classified by direct comparison with items in the training set, without ever deriving explicit patterns. The k-NN method assigns a testing sample to the class of its k nearest neighbors in the training sample, where closeness is measured in terms of some distance metric.

Neural nets are also examples of tools that predict the classification of new data, but without producing rules that a person can understand.

Naïve Bayes (“NB”) uses Bayesian rules to compute a probabilistic summary for each class of data in a data set. When given a testing sample, NB uses an evaluation function to rank the classes based on their probabilistic summary, and assigns the sample to the highest scoring class. However, NB only gives rise to a probability for a given instance of test data, and does not lead to generally recognizable rules or patterns.

Support Vector Machines (“SVM's”) handle data that is not effectively modeled by linear methods. SVM's use non-linear kernel functions to construct a complicated mapping between samples and their class attributes. The resulting patterns are those that are informative because they highlight instances that define the optimal hyper-plane to separate the classes of data in multi-dimensional space. While SVM's can handle complex data, they tend to be computationally expensive.

As illustrated, the machine learning system includes a training and predictive model 202 with training parameters 204, untrained model 208 and resampling 206 (resampling trained data 210) as inputs, and a trained predictive model 212 as an output. Thus, the training and predictive model 202 uses these inputs to generate models that are used to perform data mining recommendations and predictions.

Untrained model 208 may include, for example, algorithms that process the training data 210 in order to build or construct the trained predictive models 212. For example, in one embodiment, untrained model 208 includes, for example, algorithms that are used to build or construct data mining models that are based on neural networks. The untrained model 208 uses training parameters 204, which are parameters that are input to the data-mining model building algorithms to control how the algorithms build the models, and training data 210, which is data that is input into the algorithms, to actually build the models.

In one embodiment, the training data 210 may be constructed by resampling 206 prior to acting as input into the training a predictive model 202. As appreciated, resampling estimates the precision of sample statistics by using subsets of available data or drawing randomly with replacement from a set of data points from the original dataset.

Training and predictive model 202 implements the data mining model building algorithms included in untrained models 208, initializes the algorithms using the training parameters 204, processes training data 210 using the algorithms to build the model, and generates trained predictive model 212.

Trained predictive model 212 includes information, such as functions, that implements the conditions and decisions that make up an operational model. For example, neural network models implement a mapping between the input space and the output space. This mapping may be implemented, for example, by a combination of basic functions, which define the neural network topology, and transfer functions, which define the transfer of information between nodes in the network. Trained predictive model 212 may also be evaluated and adjusted in order to improve the quality, i.e. prediction accuracy, of the model. Trained predictive model 212 is then encoded in an appropriate format and deployed for use in making predictions or recommendations.

Once the predictive model is trained, the trained predictive mode 212 can make predictions or recommendations based on new data (i.e., data other than the training data that is from the original dataset) that is received. The trained predictive 212, prediction parameters 214 and scoring data 216 are input to scoring 218. The trained predictive model 212 includes information defining the model that was generated during construction of the training and predictive model 202, and the prediction parameters 214 are parameters that control the scoring of scoring data 216 against the trained predictive 212 and are input to the selector 222 which controls the selection of the scored data 220 and the generation of predictions and recommendations.

Scoring data 216 is processed according to the trained predictive model 212, as controlled by prediction parameters 214, to generate one or more scores for each row of data in scoring data 216. The scores for each row of data indicate how closely the row of data matches attributes of the model, how much confidence may be placed in the prediction, how likely each output prediction/recommendation to be true, and other statistical indicators. Scored data 220 is output from scoring 218 and includes predictions or recommendations, along with corresponding probabilities for the scored data.

The scored data 220 is input to the selector 222, which evaluates the probabilities associated with the predictions or recommendations and selects at least a portion of the predictions or recommendations. The selected predictions or recommendations are those having probabilities meeting the selection criteria. The selection criteria may be defined by desired results data and/or by predefined or default criteria included in the selector 220. In addition, the selection criteria may include a limit on the number of predictions or recommendations that are to be selected, or may indicate that the predictions or recommendations are to be sorted based on their associated probabilities. The selected predictions or recommendations are output from the selector 222 for use in data mining.

FIG. 3 illustrates an example process of estimating a number of samples to satisfy a query in accordance with embodiments disclosed herein. In particular, the disclosed process estimates a number of samples satisfying a query based on samples or a cloned dataset from a collection of data (an original set of data) stored in a database, such as storage system 140 (FIG. 1). The process may be implemented, for example, on the systems and components described in FIGS. 1 and 2. For purposes of discussion, the process described herein below is implemented by the server system 120. However, it is appreciated that the implementation by the server system 120 is a non-limiting example.

A database, such as storage system 140, stores a collection of data or dataset 304. In one example embodiment, the dataset 304 includes one or more tables, with rows of the table corresponding to individual records in the database. The dataset 304 in the database may be built using a variety of information and sources for each corresponding component or record of the database, and may include both training and test data.

From the dataset 304, the server system 120 randomly generates samples in the database at 306. For example, as a result of the sampling, k samples exists, in which the number of samples k is much less than the original dataset. To generate the random samples, numerous algorithms exist in which multiple random points of data (samples) may be generated from a larger set of data in the database. Such algorithms include, but are not limited to, random forests, tree bagging, extra trees, nearest neighbors, and the like.

In one embodiment, a cloned dataset is used in place of the randomly generated samples. Cloned datasets, similar to a sampled dataset, may be generated using various well-known cloning techniques.

The randomly generated samples (or cloned dataset) 306 are then used to randomly draw a number of subsets 308. In one embodiment, the subsets 308 are of distinct sizes. A subset is a subset of a set on n elements containing exactly k elements. The number of k subsets on n elements is therefore given by the binomial coefficient

$$( \begin{matrix}n \\ k\end{matrix} ) ,$$

where the k subsets of a list can be enumerated as subsets [list, {k}]. Thus, the total number of distinct k subsets 308 on a set of n elements (i.e., the number of subsets) is given by

$${Σ}_{k} ( \begin{matrix}n \\ k\end{matrix} ) = {2}^{n} .$$

For example, the generated subsets have distinct sizes, such as k₁=3,000, k₂=4,000 and kᵢ=5,000, where k₁<k₂< . . . <kᵢ.

A query 302, such as a query composed by a user with query tool 108 (FIG. 1), queries on the subsets of distinct sizes 308 to determine a number of cardinalities. The data returned as a result of the query 302 will be used as training data 310. In particular, for any given query 302, there are n₁, n₂, . . . , nᵢ samples in the subsets with distinct sizes, respectively. Accordingly, the training data 310 is represented as T={(k₁, n₁), (k₂, n₂), . . . , (kᵢ, nᵢ)}. That is, the training data 310 is a set of data defined by pairs (e.g., (kᵢ, nᵢ)) of a distinct size and a sample that satisfy the query 302 on each specific subset.

Based on the training data 310, a selected prediction model f(x) (untrained model 208 in FIG. 2) may be trained to constructed the trained predictive model 212 which satisfies the query 302. Here, the ‘x’ in f(x) represents the number of cardinalities from querying on the subsets of data. As noted above, any number of predictive learning techniques (i.e., machine learning), such as the Naïve Bayes, k-nearest neighbor algorithm, support vector machines, random forests, boosted trees, regression, etc., may be employed to build or construct the model with the training data 310 as an input.

In one embodiment, as depicted in the figure, a regression model 312 is applied as the predictive modeling technique. Regression analysis is a form of predictive modeling which investigates the relationship between a dependent (target) and independent variable(s) (predictor). This technique is used for forecasting, time series modeling and finding the causal effect relationship between the variables.

One type of regression is linear regression, which establishes a relationship between a dependent variable (Y) and one or more independent variables (X) using a best fit straight line (also known as regression line). Whereas the dependent variable is continuous, the independent variable(s) can be continuous or discrete, and the nature of the regression line is linear. The regression line is represented by an equation Y=a+b*X+e, where ‘a’ is intercept, ‘b’ is slope of the line and ‘e’ is the error term. This equation can be used to predict the value of a target variable based on given predictor variable(s), as depicted at 312.

Linear regression may involve simple linear regression, in which a single independent variable is used, or multiple linear regression in which more than one independent variable is used. In multiple linear regression, the best-fit line may be found using, for example, a least square method. The least square method calculates the best-fit line for the observed data by minimizing the sum of the squares of the vertical deviations from each data point to the line. Since the deviations are first squared, when added, there is no cancelling out between positive and negative values. The equation is represented by

$${min}_{w} {‖ Xw - y ‖}_{2}^{2} .$$

As appreciated, simple and multiple linear regression are only examples of predictive modeling. Any different number of methods may be employed as readily understood by the skilled artisan.

After training the prediction model, the trained predictive model 212 may be used to estimate a sample size of the original dataset that satisfies the query 302 using a new set of data as input into the trained predictive model 212.

FIGS. 4A-4D illustrate flow diagrams for estimating a number of samples satisfying a query in accordance with the disclosed embodiments. It is appreciated that the processes and methodologies described herein may be implemented in a client device or a server. For example, the processes described herein may be implemented in a server, such as server system 120, that obtain data from various data sources connected via the network 115. In response to a request from a client device, such as client computer system 112, the server system 120 collects data for evaluation from a database, such as storage system 140.

With reference to FIG. 4A, the data stored in the database is typically organized as tables—two-dimensional matrices made up of columns and rows. A table's primary key, is a column or combination of columns that ensures that every row in a table is uniquely identified. Two tables that have a common column are said to have a relationship between them, where the common column is the foreign key in one table and the primary key in the other. The value (if any) stored in a row/column combination is a data element (or element), as described above with reference to FIG. 3.

At 402, the server system 120 randomly draws one or more subsets of distinct sizes from a sample dataset of a collection of all data (the original dataset). The dataset (e.g., a table of data) may be stored, for example, in any database of the computing environment 100 of FIG. 1. For example, the collection of data may be stored in storage system 140, storage 104 or 124, or any other storage that is connected to or capable of being connected to the computing system 100.

Numerous well-known methods exist to sample datasets. For example, a simple random sample is a subset of a sample chosen from a larger set (e.g., a collection of data). Each sample is chosen randomly and entirely by chance, such that each sample has the same probability of being chosen at any stage during the sampling process, and each subset of k samples has the same probability of being chosen for the sample as any other subset of k samples.

After the subsets have been randomly drawn at 402, the subsets 308 may be queried to determine a number of cardinalities to be used as training data 310 at 404. For example, the query engine 132 may query the storage system 140 using a query 302 generated using query tool 108. Here, the cardinality of a relationship is the ratio of the number (also called occurrences) of data elements in two tables' related column(s).

The training data 310 may then be used to train a prediction model (untrained model) using machine learning or statistical methods at 406. As explained above, any number of different prediction models or algorithms may be employed. For example, two techniques within predictive data mining modeling are regression and classification. The usage of these two techniques generally depends on whether the target variable is continuous or categorical. If the target variable is categorical, then the predictive data mining modeling technique to use is usually classification and, if the target variable is continuous, then the most well suited form of predictive data mining modeling technique is often regression.

When regression is employed, there are several methods that can employed. For example, linear regression typically fits a linear equation to a set of observed data values, whereas nonlinear regression typically extends linear regression to fit nonlinear equations. Logistic and exponential regression modeling generally attempts to fit logistic function and exponential functions respectively. Similarly, there are several methods that can be employed in the classification modeling algorithms. The range of classification methods can include decision trees, neural networks, support-vector machines, Bayes methods, lazy learning techniques, and nearest neighbor approach, and the like.

At 408, after the prediction model has been trained with the training data 310, the server system 120 may estimate a sample size satisfying the query 302 of the collection of all data using the trained predictive model 212. For example, a new set of data from the original collection of data may be used as input data into the trained predictive model 212 such that a prediction or recommendation may be output based on the input. In this case, the prediction is the sample size of each subset. Such a prediction may be generated, for example, based on historical data by which the model has learned how to predict an appropriate output value.

In one embodiment, as shown in FIG. 4B, prior to drawing the subsets at 402, the server system 120 randomly generates samples to form the sample dataset from the collection of data stored in the database, such as storage system 140 at 410. Similarly, prior to training the predictive model 212, the server system 120 constructs the training data for resampled subsets. Resampling, in this context, refers to estimating the precision of sample statistics using subsets of available data or drawing randomly with replacement from a set of data points.

With reference to FIG. 4C, in one embodiment, each of the randomly generated subsets has a distinct size that corresponds to the number of samples at 414. For example, a first subset is said to have a size of 5,000 when the subset has 5,000 samples.

With reference to FIG. 4D, in one embodiment, the training data as a set of data defined by pairs of a distinct size and the number of samples that satisfy the query for a corresponding subset(s), at 416.

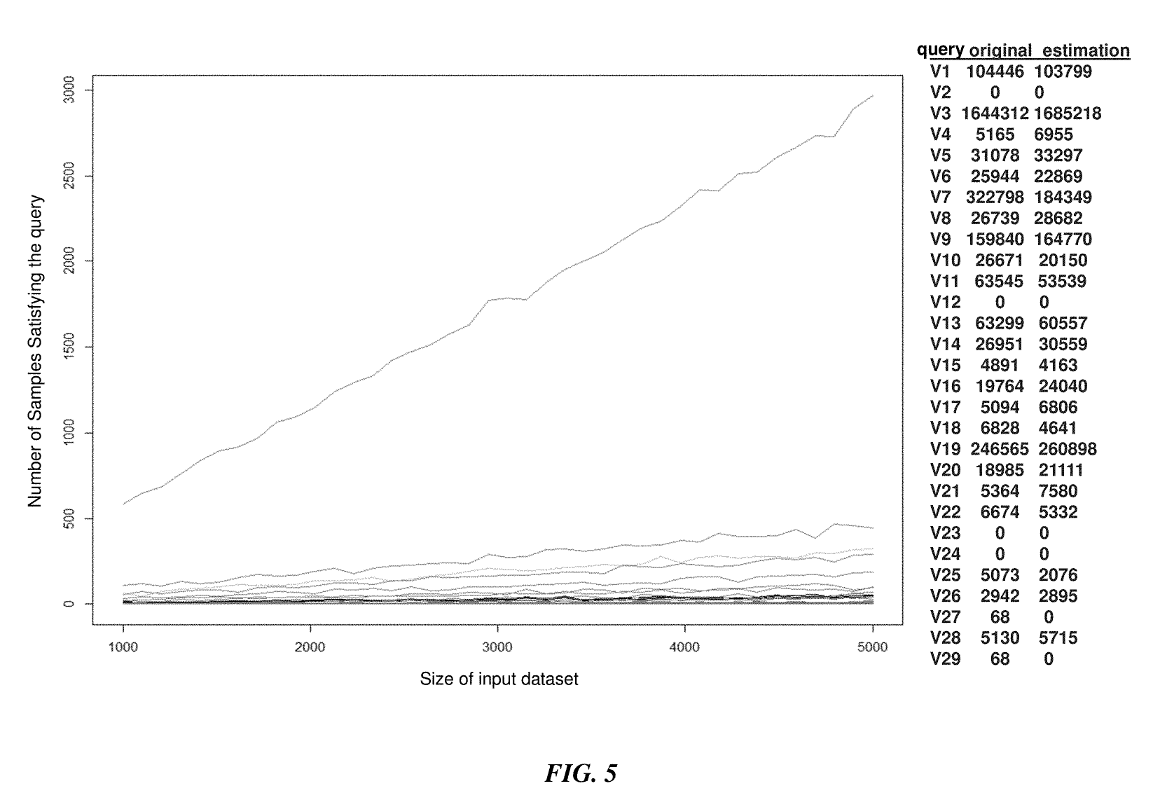

FIG. 5 illustrates a chart representing sample sizes estimated based on the trained predictive model. As illustrated, the graphical model shows a size of an input dataset (i.e., a subset of data) across the x-axis and the number of samples that satisfy a particular query on the y-axis. The table to the right of the diagram has three columns, a query (Vi), the original sample amount and the estimated sample amount (using the predictive modeling), where the output is charted in the depicted graph. It is appreciated that the disclosed data and graphical representation are an example, and that any number of different data and data sizes may be applied in the model.

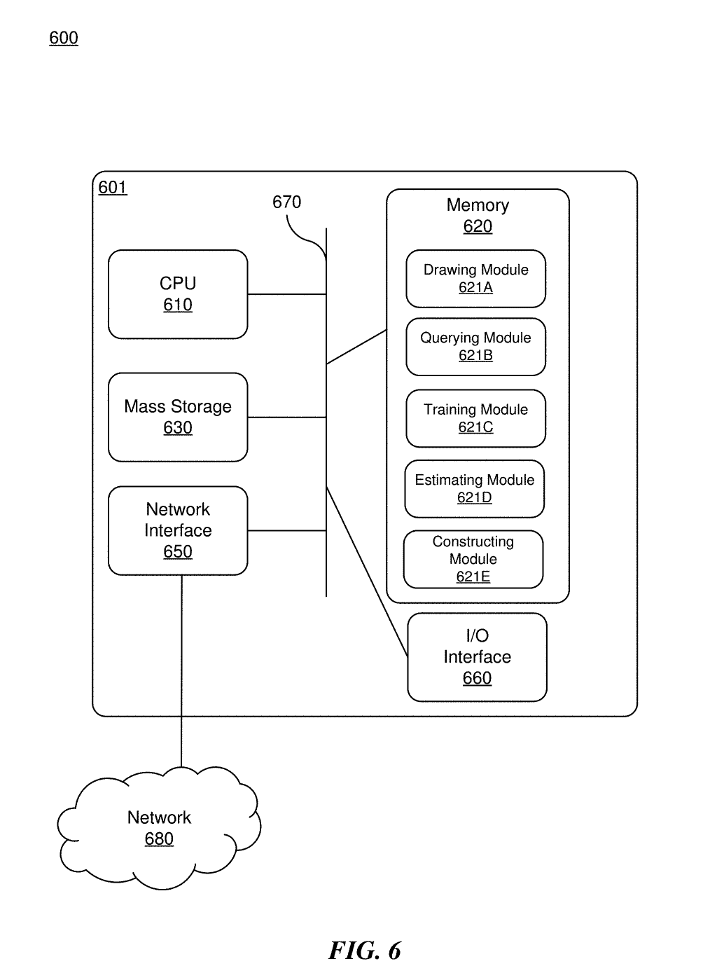

FIG. 6 is a block diagram of a network device that can be used to implement various embodiments. Specific network devices may utilize all of the components shown, or only a subset of the components, and levels of integration may vary from device to device. Furthermore, the network device 600 may contain multiple instances of a component, such as multiple processing units, processors, memories, transmitters, receivers, etc. The network device 600 may comprise a processing unit 601 equipped with one or more input/output devices, such as network interfaces, storage interfaces, and the like. The processing unit 601 may include a central processing unit (CPU) 610, a memory 620, a mass storage device 630, and an I/O interface 660 connected to a bus 670. The bus 670 may be one or more of any type of several bus architectures including a memory bus or memory controller, a peripheral bus or the like.

The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs. In embodiments, the memory 620 is non-transitory. In one embodiment, the memory 620 includes drawing module 621A drawing one or more subsets from a sample dataset of a collection of all data, a querying module 621B querying on the one or more subsets to determine a number of cardinalities as training data, and a training module 621C training a prediction model based on the training data using machine learning or statistical methods. An estimating module 621D estimating a sample size satisfying the database query of the collection of all data using the trained prediction model, and a constructing module 621E constructing the training data for one or more resampled subsets.

The mass storage device 630 may comprise any type of storage device configured to store data, programs, and other information and to make the data, programs, and other information accessible via the bus 670. The mass storage device 630 may comprise, for example, one or more of a solid state drive, hard disk drive, a magnetic disk drive, an optical disk drive, or the like.

The processing unit 601 also includes one or more network interfaces 650, which may comprise wired links, such as an Ethernet cable or the like, and/or wireless links to access nodes or one or more networks 680. The network interface 650 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

According to the embodiments, the disclosed technology provides the following advantages, including, but not limited to, a distribution-free method that works for any combination of continuous and discrete random variables, the training data is generated by the specific query, and the technology is intrinsically parallelizable in generating the training data for the prediction model.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for estimating a number of samples satisfying a database query, the method comprising:
randomly drawing one or more subsets from a sample dataset of a collection of all data;
querying on the one or more subsets to determine a number of cardinalities as training data;
training a prediction model based on the training data using machine learning or statistical methods; and
estimating a sample size satisfying the database query of the collection of all data using the trained prediction model.

2. The method of claim 1, further comprising:
randomly generating one or more samples to form the sample dataset from the collection of data stored in the database; and
constructing the training data for one or more resampled subsets.

3. The method of claim 2, wherein each of the randomly generated one or more subsets has a distinct size corresponding to the number of samples.

4. The method of claim 2, wherein the training data is a set of data defined by pairs of a distinct size and the number of samples that satisfy the query for a corresponding one of the one or more subsets.

5. The method of claim 1, wherein determining the number of samples in each of the one or more subsets that satisfy the given query is performed by one or more processors in parallel.

6. A device for estimating a number of samples satisfying a database query, comprising:
a non-transitory memory storage comprising instructions; and
one or more processors in communication with the memory, wherein the one or more processors execute the instructions to perform operations comprising:
randomly drawing one or more subsets from a sample dataset of a collection of all data;
querying on the one or more subsets to determine a number of cardinalities as training data;
training a prediction model based on the training data using machine learning or statistical methods; and
estimating a sample size satisfying the database query of the collection of all data using the trained prediction model.

7. The device of claim 6, the one or more processors further execute the instructions to perform operations comprising:
randomly generating one or more samples to form the sample dataset from the collection of data stored in the database; and
constructing training data for one or more resampled subsets.

8. The device of claim 7, wherein each of the randomly generated one or more subsets has a distinct size corresponding to the number of samples.

9. The device of claim 7, wherein the training data is a set of data defined by pairs of a distinct size and the number of samples that satisfy the query for a corresponding one of the one or more subsets.

10. The device of claim 6, wherein determining the number of samples in each of the one or more subsets that satisfy the given query is performed by one or more processors in parallel.

11. A non-transitory computer-readable medium storing computer instructions for estimating a number of samples satisfying a database query, that when executed by one or more processors, perform the steps of:
randomly drawing one or more subsets from a sample dataset of a collection of all data;
querying on the one or more subsets to determine a number of cardinalities as training data;
training a prediction model based on the training data using machine learning or statistical methods; and
estimating a sample size satisfying the database query of the collection of all data using the trained prediction model.

12. The non-transitory computer-readable medium of claim 11, wherein the one or more processors further perform the steps of:
randomly generating one or more samples to form the sample dataset from the collection of data stored in the database; and
constructing training data for one or more resampled subsets.

13. The non-transitory computer-readable medium of claim 12, wherein each of the randomly generated one or more subsets has a distinct size corresponding to the number of samples.

14. The non-transitory computer-readable medium of claim 12, wherein the training data is a set of data defined by pairs of a distinct size and the number of samples that satisfy the query for a corresponding one of the one or more subsets.

15. The non-transitory computer-readable medium of claim 11, wherein determining the number of samples in each of the one or more subsets that satisfy the given query is performed by one or more processors in parallel.
